(19) United States
(12) Patent Application Publication
(10) Pub. No.: US 2020/0027090 A1
(43) Pub. Date: Jan. 23, 2020

(54) SYSTEMS AND METHODS FOR AUTHENTICATING FINANCIAL TRANSACTIONS

(71) Applicant: Mastercard International Incorporated, Purchase, NY (US)

(72) Inventor: Aaron P. Braundmeier, St. Peters, MO (US)

(73) Assignee: Mastercard International Incorporated, Purchase, NY (US)

(21) Appl. No.: 16/038,010

(22) Filed: Jul. 17, 2018

(51) Int. Cl. G06Q 20/40; G06Q 20/32

(52) U.S. Cl. CPC G06Q 20/40145; G06Q 20/32

(57) ABSTRACT

A computer-implemented method for verifying a financial transaction conducted over a payment network. One step of the method includes obtaining comparative biometric data and comparative metadata from a payment device associated with a payment account. An additional step includes comparing the comparative biometric data with historical biometric data associated with a payment account and comparing the comparative metadata with historical metadata associated with the payment account. A further step includes authorizing the financial transaction if: (i) the comparative biometric data matches the historical biometric data and (ii) the comparative metadata corresponds to the historical metadata.

### BACKGROUND

### 1. Field of the Invention

The present disclosure is generally related to systems and methods for validating payment transactions. More particularly, the present disclosure is generally related to systems and methods for authenticating payment transactions by analyzing biometric data and metadata associated with a payment account.

### 2. Description of the Related Art

The use of credit and debit cards for payment transactions is now commonplace. Unfortunately, at least some of such payment transactions involve fraudulent activity. Fraudulent payment transactions present liability concerns to issuing banks, acquiring banks, merchants, payment processing networks, and/or the like. As such, these parties are interested in fraud-detection procedures, or the ability to analyze the data surrounding payment transactions so as to validate the payment transactions before final authorization of the payment transactions occur.

One common fraud-detection procedure involves cardholder authentication, in which interchange networks implement an authentication service platform that performs an authentication of a cardholder prior to authorization of a payment transaction initiated by such cardholder. The authentication service platform determines if the source of the payment transaction is the authorized cardholder of the payment card. If the source of the payment transaction is not the authorized cardholder, then the payment transaction may be declined.

In addition to cardholder authentication, other previously-used fraud-detection procedures include the use of a fraud-scoring system to detect potentially-fraudulent payment transactions. For example, some fraud-detection processes may analyze information related to payment transactions so as to determine if any of such information is indicative of fraud. If fraud (or potential fraud) is detected, then the payment transaction may be declined.

The above-described fraud-detection procedures have drawbacks because they can miss or overlook certain fraudulent payment transactions, or, alternatively, they can improperly reject valid payment transactions as being fraudulent (i.e., generate false positives). Furthermore, fraudulent actors have been known to manipulate transaction messages, which are generated in association with payment transactions, so as to make the payment transactions appear valid, even if such payment transactions are fraudulent.

### SUMMARY

One or more embodiments of the present invention generally concern a computer-implemented method for verifying a financial transaction conducted over a payment network. Generally, the method comprises the steps of: (a) obtaining comparative biometric data and comparative metadata from a payment device; (b) comparing the comparative biometric data with historical biometric data associated with a payment account; (c) comparing the comparative metadata with historical metadata associated with the payment account; and (d) authorizing the financial transaction if (i) the comparative biometric data matches the historical biometric data, and (ii) the comparative metadata corresponds to the historical metadata.

One or more embodiments of the present invention may also concern a financial transaction verification system for a payment network. Generally, the financial transaction verification system comprises: (a) a memory device for storing data and (b) a processor communicatively coupled to the memory device. The processor may be programmed to: (i) obtain comparative biometric data and comparative metadata from a payment device, (ii) compare the comparative biometric data to historical biometric data associated with a payment account, (iii) compare the comparative metadata to historical metadata associated with the payment account, and (iv) authorize the financial transaction if the comparative biometric data matches the historical biometric data and the comparative metadata corresponds to the historical metadata.

One or more embodiments of the present invention may also concern a non-transitory computer-readable storage media having computer-executable instructions for verifying a financial transaction conducted over a payment network stored thereon. When executed by at least one processor the computer-executable instructions cause the processor to: (a) obtain comparative biometric data and comparative metadata from a payment device; (b) compare the comparative biometric data to historical biometric data associated with a payment account; (c) compare the comparative metadata to historical metadata associated with the payment account; and (d) authorize the financial transaction if the comparative biometric data matches the historical biometric data and the comparative metadata corresponds to the historical metadata.

### BRIEF DESCRIPTION OF THE FIGURES

Embodiments of the present invention are described herein with reference to the following drawing figures, wherein:

FIG. 1 is a block diagram of an exemplary multi-party payment network system having a payment transaction validation module (PTV module) according to embodiments of the present invention;

FIG. 2 is another block diagram of an exemplary payment card network system, such as the payment card network system shown in FIG. 1, including a plurality of client computing systems connected to a server system of an interchange network, and with the PTV module from FIG. 1 illustrated in association with the server system;

FIG. 3 illustrates an exemplary configuration of the server system shown in FIG. 2;

FIG. 4 illustrates an exemplary configuration of a client computing system from FIG. 2;

FIG. 5 is a flow chart depicting an exemplary method that may be implemented in the system of FIG. 1 for authenticating a financial transaction instituted by an alleged cardholder; and

FIG. 6 is a flow chart depicting selected steps in an exemplary method that may be implemented in the system of FIG. 1 for authenticating a financial transaction instituted by an alleged cardholder.

### DETAILED DESCRIPTION

The following detailed description of the present invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to validating payment transactions made using payment network systems. However, the scope of the present invention is defined only by the appended claims, along with the full scope of equivalents to which such claims are entitled.

Broadly characterized, the present invention relates to systems and methods for validating payment transactions. More particularly, the disclosed embodiments provide systems and computer-implemented methods for validating a payment transaction by analyzing biometric data and metadata (e.g., Exchangeable Image File Format (EXIF) data) associated with a payment account. In one or more embodiments, the disclosed embodiments provide systems and methods for verifying a financial transaction conducted over a payment network that involves: (a) obtaining comparative biometric data and comparative metadata from a payment device, (b) comparing the comparative biometric data with historical biometric data associated with a payment account, (c) comparing the comparative metadata with historical metadata associated with the payment account, and (d) authorizing the financial transaction if (i) the comparative biometric data matches the historical biometric data and (ii) the comparative metadata corresponds to the historical metadata. Thus, the disclosed systems and methods of the present invention may provide fraud-detection procedures that utilize both biometric data and metadata associated with a payment device (e.g., a mobile phone, laptop, personal computer, tablet, smartphone, PDA, POS device, etc.).

Typically, cardholders may authenticate themselves to the payment accounts when initiating financial transactions by presenting identification to the merchants, such as providing reference signatures and/or personal identification numbers (PINs). Additionally, biometric data has been used to help verify the identity of cardholders and, therefore, better authenticate financial transactions therefrom. The systems and methods of the present invention allow cardholders to better verify their identifies through the use of biometric data (e.g., image data, fingerprint data, voice data, retina data, heart rate data, and/or other known biometric data types) and metadata (e.g., Exchange Image File Format (EXIF)) associated with a payment device.

In one or more embodiments, the biometric data may include image data of the cardholder. For example, the biometric data may include image data stored in payment cards associated with the payment accounts, whereby the cardholders may be authenticated to their payment accounts at point-of-sale devices (e.g., POS terminals, mobile POS devices, other POS devices, etc.) used to facilitate the financial transactions. More specifically, a cardholder may capture an initial image of their face, including, for example, a “selfie” image captured by the cardholder using a mobile device (e.g., a mobile phone, tablet, etc.). That initial image can then be provided to a payment network, which stores the image in association with the cardholder's payment account. This initial image can serve as “historical” biometric data, or in other words, the image data to which subsequent images of the cardholder will be compared. When beginning a new financial transaction, the cardholder is able to present the payment card to a merchant, who may then capture a current image from the cardholder by a point-of-sale device and send the current image to the payment network for verification. Alternatively, the current image may be captured using the cardholder's personal payment device (e.g., mobile phone, smart phone, PDA, tablet, computer, mobile device, etc.), which has a camera. This current image may function as a “comparative” image and be compared to the “historical” image data stored on the payment network. Thus, this image data can help verify the identity of the cardholder and authenticate the ongoing financial transaction. Although the exemplary process described above uses image data, other forms of biometric data may be used and collected at the point-of-sale devices and/or from the cardholder's payment device (e.g., fingerprint data, voice data, retina data, heart rate data, and/or other know biometric data types).

Although biometric data is highly useful for verifying a cardholder's identity, the systems and methods of the present invention also utilize metadata, such as Exchangeable Image File Format (EXIF) data, associated with a cardholder's payment device (e.g., mobile phone, smart phone, PDA, tablet, computer, mobile device, etc.). The use of metadata may add layers of security to any financial transactions originating from a cardholder's personal payment device, particularly those with cameras. This would include, for example, financial transactions that use “Selfie Pay” applications or any other financial applications that utilize image data from a mobile payment device. The metadata from the cardholder's payment device (e.g., metadata associated with geolocation, time and date, camera model, camera sensor, mobile device model, etc.) can be collected by the payment network and associated with a cardholder's payment account. When a new financial transaction is instituted, this “historical” metadata can then be compared to any current metadata generated from the payment device associated with the new financial transaction, which can better enhance the verification and authorization process. For instance, when the cardholder sends a current selfie image of themselves with their payment device to compare against the historical image data on the payment network to authenticate a new financial transaction, the metadata from this payment device can also be obtained and compared to the historical metadata stored on the payment network. The comparative metadata can be compared to the historical metadata to further verify the identity of the cardholder and authenticate the new financial transaction. Thus, this use of metadata can allow extra layers of security when authenticating a financial transaction.

In one exemplary embodiment, a cardholder can log into a payment application on their personal payment device, such as the “Selfie Pay” by Mastercard®, at which time certain historical metadata (e.g., timestamps, geolocation, camera model, device model, etc.) from the payment device may be collected by the payment network. Additionally, the payment network may also collect any current biometric data (e.g., a current selfie image) captured by the payment device upon commencement of a new financial transaction. This new and current metadata and biometric data will be compared to the “historical” metadata and biometric data associated with the payment account that is stored on the payment network. The financial transaction may be approved and authenticated if the comparative biometric data matches the historical biometric data and the collected metadata corresponds to the historical metadata. If either the comparative biometric data fails to match the historical biometric data or the comparative metadata fails to correspond to the historical metadata, then the financial transaction can be (a) flagged as a suspicious transaction (and subsequently terminated) or (b) upheld until the cardholder submits further authentication.

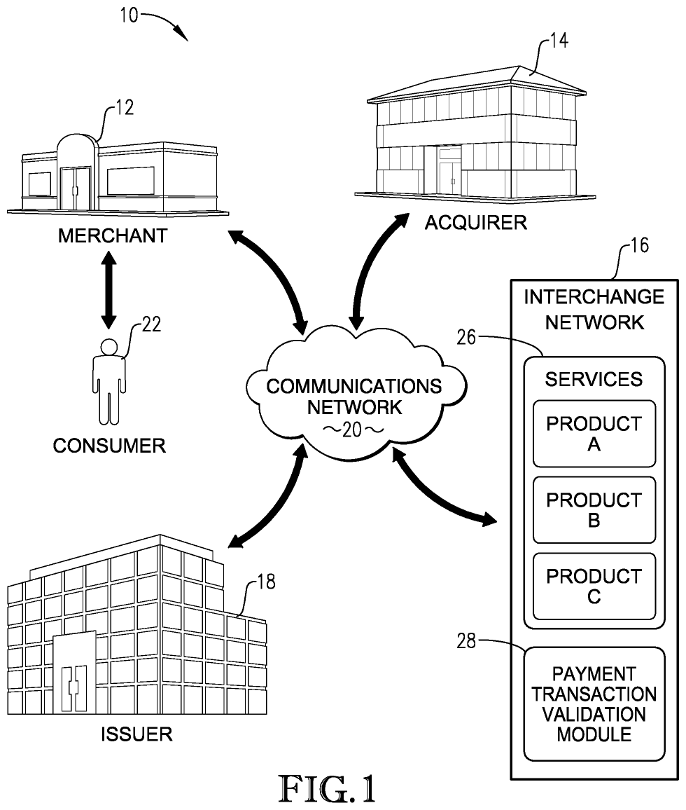

An exemplary system for implementing embodiments of the present invention will now be described with reference to FIG. 1, a block diagram of an exemplary multi-party payment network system 10. In general, the payment network system 10 is configured to enable payment transactions, such as payment-by-card transactions, through operation of a number of interconnected parties, including merchants 12, acquirers 14, interchange networks 16, and/or card issuers 18. Embodiments described herein may relate to a payment network system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. Mastercard is a registered trademark of Mastercard International Incorporated located in Purchase, N.Y.

As used herein, financial transaction data may include transaction messages, which are unique data messages that include information related to payment transactions initiated via payment cards (e.g., credit or debit cards). Broadly, a transaction message may include data fields populated with various types of data or information related to a payment transaction made with a payment card. For example, such data may include: (1) an account or card number associated with the payment card; (2) purchase data representative of the payment transaction, e.g., a type of merchant, amount of purchase, date of purchase, and the like; (3) biometric data associated with the payment card; and/or (4) metadata associated with a payment device of the payment card. As will be described in more detail below, the transaction messages for a given payment transaction may be transmitted between the various parties of the payment network system 10 for purposes of validating the payment transaction and settling of funds related to the payment transaction.

As noted above, in the exemplary embodiment of FIG. 1, the payment network system 10 may generally include the merchant 12, the acquirer 14, the interchange network 16, and the issuer 18, coupled in communication via a communications network 20. As such, a cardholder 22 (e.g., a consumer), who is an authorized user of a payment card, can initiate a payment transaction over the payment network system 10 to make a purchase from a merchant 12. The communications network 20 used to interconnect the parties of the payment network system 10 may include various types of networks, such as one or more of a local area network (LAN), a wide area network (WAN) (e.g., the Internet, etc.), a mobile network, a virtual network, and/or any other suitable public and/or private network capable of facilitating communication among the merchant 12, the acquirer 14, the interchange network 16, and/or the issuer 18. In some embodiments, the communications network 20 may include more than one type of network, such as a private payment transaction network provided by the interchange network 16 to the acquirers 14 and the issuers 18 and, separately, the public internet, which may facilitate communication between the merchants 12 and (1) the interchange network 16, (2) the acquirers 14, and/or (3) the cardholder 22.

The payment network system 10 may facilitate payment transactions made by the cardholder 22. In typical systems, a financial institution, referred to as an “issuing bank” or the issuer 18, issues a payment card, such as a credit or debit card, to a cardholder 22, who uses the payment card to tender payment for purchases made from a merchant 12. Merchants 12 are typically associated with products, for example, and without limitation, goods and/or services, that are offered for sale and are sold to the cardholder 22. The merchant 12 may include, for example, a physical location and/or a virtual location. A physical location includes, for example, a brick-and-mortar store, etc., and a virtual location includes, for example, an internet-based store-front.

To accept payment with the payment card, the merchant 12 generally has established an account with a financial institution that is part of the payment network system 10. This financial institution is generally referred to as a “merchant bank,” an “acquiring bank,” or the acquirer 14. When the cardholder 22 tenders payment for a purchase with a payment card, the merchant 12 requests authorization from the acquirer 14 for the amount of the purchase. The request may be performed over the telephone, but is usually performed through the use of a computing device, such as a point-of-sale terminal, that reads the cardholder's 22 account information from a magnetic stripe, a chip, or embossed characters on the payment card and generates a transaction message, in the form of an authorization request, which is communicated electronically to transaction processing computers of the acquirer 14. Alternatively, the acquirer 14 may authorize a third party to perform transaction processing on its behalf. In such cases, the merchant's 12 point-of-sale terminal will be configured to communicate with the third party. Such a third party is generally referred to as a “merchant processor,” an “acquiring processor,” or a “third-party processor.”

Using the interchange network 16, computing devices of the acquirer 14 or merchant processor can communicate with computing devices of the issuer 18 to determine whether the cardholder's 22 account is in good standing and whether the purchase is covered by the cardholder's 22 available credit line or account balance. Again, such communication generally involves the interchange network 16 providing the transaction message to the issuer 18, such that the issuer 18 can verify that the cardholder's 22 account has sufficient funds to cover the payment transaction. Based on these determinations, the payment transaction can be declined or accepted. Specifically, the issuer 18 can generate a transaction message, in the form of an authorization response, which indicates whether the payment transaction should be declined or accepted. The transaction message can be sent from the issuer 18, via the interchange network 16 and/or the acquirer 14, to the merchant 12 such that the cardholder 22 can be informed as to whether the payment transaction is declined or accepted.

When a request for authorization of the payment transaction is accepted, the available credit line or account balance of the cardholder's 22 account is decreased. Normally, a charge for an online payment card transaction is not posted immediately to the cardholder's 22 account because bankcard associations, such as Mastercard International Incorporated, have promulgated rules that do not allow the merchant 12 to charge, or “capture,” a payment transaction until the purchased goods are shipped or the purchased services are delivered. However, with respect to at least some debit card transactions, a charge may be posted at the time of the payment transaction. When the merchant 12 ships or delivers the goods or services, the merchant 12 captures the payment transaction by, for example, appropriate data entry procedures on the point-of-sale terminal. This may include bundling of approved transactions daily for standard retail purchases. If the cardholder 22 cancels a payment transaction before it is captured, a “void” is generated. If the cardholder 22 returns goods after the transaction has been captured, a “credit” is generated. For debit card transactions, when a request for a personal identification number (PIN) authorization is requested and is approved by the issuer 18, the cardholder's 22 account is decreased. Normally, a charge is posted immediately to the cardholder's account. The interchange network 16 transmits the approval to the acquirer 14 for distribution of goods/services or information, or cash in the case of an automated teller machine (ATM).

After a purchase has been made, a clearing process occurs to transfer additional financial transaction data related to the purchase transaction among the parties of the payment network system 10, such as the acquirer 14, the interchange network 16, and the issuer 18. More specifically, during and/or after the clearing process, additional financial transaction data, such as a time of purchase, a merchant name, a type of merchant, purchase information, cardholder account information, a type of transaction, itinerary information, information regarding the purchased item and/or service, biometric data associated with the cardholder, metadata associated with the payment device of the cardholder, and/or other suitable information, may be associated with the payment transaction and transmitted between parties to the payment transaction, and may be stored (e.g., in databases) by any of the parties.

After a payment transaction is authorized and cleared, the payment transaction is settled among the merchant 12, the acquirer 14, and the issuer 18. Settlement refers to the transfer of financial transaction data and/or funds among the merchant's 12 account, the acquirer 14, and the issuer 18 related to the transaction. Usually, payment transactions are captured and accumulated into a “batch,” which is settled as a group. More specifically, a payment transaction is typically settled between the issuer 18 and the interchange network 16, then between the interchange network 16 and the acquirer 14, and then between the acquirer 14 and the merchant 12.

With continued reference to FIG. 1, the interchange network 16 is generally used to facilitate communication and financial transaction data processing between the parties of the payment network system 10. In addition, however, the interchange network 16 may be configured to offer or provide one or more services 26 (e.g., Product A, Product B, Product C, etc.) to one or more of its clients, which may include the merchants 12, the acquirer 14, the issuer 18, and/or the cardholder 22. The services may be referred to as value-added services 26, for example, in that the services are often provided in addition to the standard interchange network 16 goal of coordinating payment transactions initiated by the cardholders 22. Exemplary services include, for example and without limitation, fraud services (e.g., fraud detection, fraud scoring, etc.), loyalty services (e.g., managing reward points, etc.), account control services (e.g., transaction limits, etc.), authentication services, routing intelligence services, message transformation services (e.g., format and/or standard conversions, etc.), services for applying additional derived data and/or insights to transaction messages, identification of other value added services to be applied, etc.

Embodiments of the present invention provide for the interchange network 16 to be configured to offer or provide a specific value-added service 26, in the form of a fraud-detection and identification service, which can be used to validate payment transactions. This fraud-detection service for validating payment transactions may be implemented by a payment transaction verification (PTV) module 28, which is illustrated schematically as part of the interchange network 16 of FIG. 1. The PTV module 28 may be configured as a specially-programmed computer system that enables the interchange network 16 to implement an automated process or routine to analyze biometric data and current metadata obtained from a cardholder 22 initiating a payment transaction. Based on the PTV module's 28 analyses of the biometric data and the current metadata, payment transactions can be authorized or denied/declined. As will be described in more detail below, the PTV module 28 may comprise a computing device in the form of one or more processing elements communicatively coupled with one or memory elements with a computer program stored thereon (e.g., a computer-readable storage media or medium comprising a non-transitory medium with an executable computer program stored thereon), such that the PTV module 28 can be specially programmed to (1) receive transaction messages associated with payment transactions, (2) analyze one or more fields included within the transaction messages, and (3) validate the payment transactions based on such analyses, such that the payment transactions can be authorized or denied.

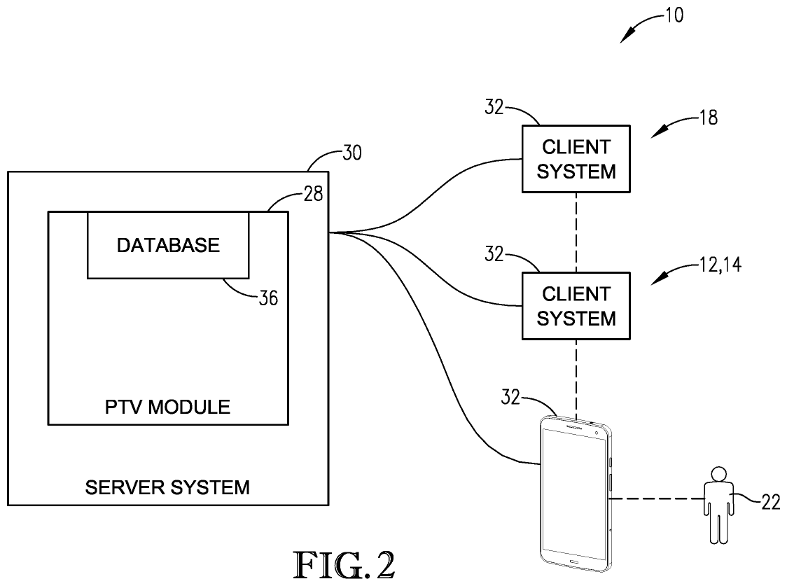

FIG. 2 is another simplified block diagram of the exemplary payment network system 10. The block diagram of FIG. 2 may be considered an alternate description of the components of the payment network system 10 described above. The payment network system 10 of FIG. 2 includes a plurality of computing devices such as, for example, the PTV module 28, a server system 30, and one or more client systems 32 all connected via a communications network, such as the internet. The server system 30 may comprise a server-type computing device of the interchange network 16, which is particularly configured to perform various functions and features described herein on behalf of the interchange network 16. Similarly, the PTV module 28 may comprise a computing device of the interchange network 16, which is particularly configured to obtain and analyze current biometric data and metadata from the cardholder instituting a new financial transaction. In some embodiments, the PTV module 28 may be incorporated within the server system 30. In alternate embodiments, the PTV module 28 may be separate from the server system 30. In contrast, the client systems 32 may be computing devices of clients, such as the merchant 12, the acquirer 14, the issuer 18, and/or the cardholder 22, which are in communication with the server system 30 via the communications network. It is noted that the payment network system 10 may include more, fewer, or alternative components and/or perform more, fewer, or alternative actions, including those discussed elsewhere herein.

In more detail, the server system 30 may be associated with the interchange network 16 and may be referred to as an interchange computer system. Broadly, the server system 30 may be used for processing financial transaction data associated with payment transactions. In some embodiments, the server system 30 may include, or otherwise be associated with a database 36, which is configured to store information about a variety of matters, such as may be necessary for processing financial transaction data. In some embodiments, the database 36 may comprise a centralized database stored on the server system 30. In some embodiments, the database 36 may be associated with the PTV module 28. In an alternative embodiment, the database 36 may be stored remotely from the server system 30 and/or the PTV module 28, such as in the form of a distributed or non-centralized database. In one exemplary embodiment, the database 36 may include a single database having separated sections or partitions or may include multiple databases, each being separate from each other. In some embodiments, for example, where the database 36 includes separate sections, partitions, or multiple databases, the database 36 may be configured to store financial transaction data generated as part of payment transactions conducted over the payment network system 10 including data relating to cardholders 22, issuers 18, acquirers 14, and/or payment transactions.

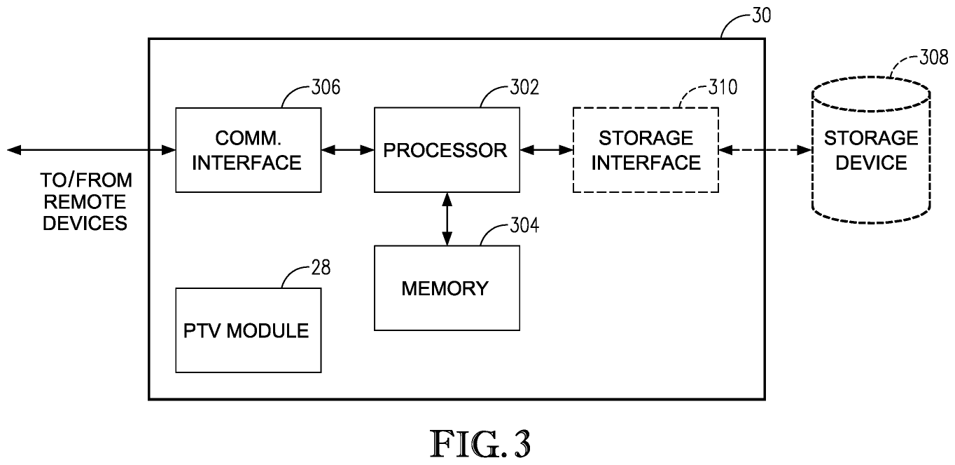

FIG. 3 illustrates an exemplary configuration of the server system 30 in more detail. In the exemplary embodiment, the server system 30 may include, for example, and without limitation, the server 36 and the PTV module 28. The server system 30 may additionally include one or more processors 302 for executing instructions, processes, code segments, routines, or the like, which may be stored in a memory 304. The processor 302 may include one or more processing units (e.g., in a multi-core configuration) for executing instructions. The instructions may be executed within a variety of different operating systems on the server system 30, such as UNIX, LINUX, Microsoft Windows®, etc. It should also be appreciated that upon initiation of a computer-implemented method, various instructions may be executed during initialization. Some operations may be required in order to perform one or more processes described herein, while other operations may be more general and/or specific to a particular programming language (e.g., C, C#, C++, Java, or other suitable programming languages, etc.).

The memory 304 of the server system 30 may be communicatively coupled with the processor 302 and may include, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

The processor 302 may be operatively coupled to a communication interface 306 such that the server system 30 is capable of communicating with a remote device such as a client system 32 or another server system 30. For example, the communication interface 306 may communicate with the client systems 32 via the internet. The processor 302 may also be operatively coupled to a storage device 308. The storage device 308 may comprise any computer-operated hardware suitable for storing and/or retrieving data. In certain embodiments, the storage device 308 may provide or make available the database 36, described above, which can be used by the sever system 30. In some embodiments, the storage device 308 may be integrated in the server system 30 and/or in the PTV module 28. For example, the server system 30 may include one or more hard disk drives that comprise the storage device 308. In other embodiments, the storage device 308 may be external to the server system 30 and may be accessed by the server systems 30 via a storage interface 310 described in more detail below. The storage device 308 may include multiple storage units such as hard disks or solid-state disks in a redundant array of inexpensive disks (RAID) configuration. The storage device 308 may include a storage area network (SAN) and/or a network attached storage (NAS) system.

As noted, the processor 302 may be operatively coupled to the storage device 308 via the storage interface 310. The storage interface 310 may comprise any component capable of providing the processor 302 with access to the storage device 308. The storage interface 310 may include, for example, and without limitation, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 308.

Embodiments provide for the PTV module 28 to be a component of the server system 30 or, alternatively, to be a separate computing device. As such, the PTV module 28 can be used, as will be described in more detail below, to perform routines for validating payment transactions by obtaining, analyzing, and verifying current biometric data and current metadata from a payment device in response to initiated payment transactions. In embodiments in which the PTV module 28 is incorporated within the server system 30, the PTV module 28 may be a specifically-programmed section of the server system 30. As such, the PTV module 28 may use the processor 302, the memory 304, the communications interface 306, and/or the storage device 308 of the server system 30. In alternate embodiments, the PTV module 28 may be a separate computing device (which may be communicatively coupled with) the server system 30. In such embodiments, the PTV module 28 may include its own processor, memory, communications interface, and/or the storage device, similar to those components described above with respect to the server system 30. In such embodiments, for example, the PTV module 28 may be independently associated with the interchange network 16 or with an outside third party in a contractual relationship with the interchange network 16.

Returning to FIG. 2, the client systems 32 may include various computer systems associated with the merchant 12 and/or acquirer 14 (shown in FIG. 1), as well as the issuer 18 (also shown in FIG. 1). Another client system 32 may be a computing device associated with a cardholder 22. It should be understood, however, the client systems 32 may be computer systems associated with other entities, such as online banks, bill payment outsourcers, processors, billers, or another entity associated with the payment network system 10.

As will be described in more detail below, the interchange network 16, and specifically the PTV module 28 of the interchange network 16, can obtain current biometric data and metadata from the client system 32 (e.g., a payment device) of the consumer 22 when a new financial transaction is instituted.

To begin, a sender, which may include the merchant 12 and/or the acquirer 14, can generate and send a transaction message (in the form of an authorization message) to the interchange network 16 in response to a consumer 22 initiating a payment transaction at the merchant 12. The PTV module 28 is configured to obtain and store historical biometric data (e.g., reference image data) and historical metadata associated with a client system 32 (e.g., a payment device) of the consumer 22. Additionally, the PTV module 28 is also configured to obtain comparative biometric data (e.g., a current image) and comparative metadata from the payment device 32 whenever a new financial transaction is initiated by the consumer 22. The PTV module 28 can then analyze and compare the comparative biometric data with the historical biometric data and the up-to-date metadata with the historical metadata. If the PTV module 28 determines that the comparative biometric data fails to match the historical biometric data and/or if the comparative metadata fails to correspond to the historical metadata, then the interchange network 16 may send a payment transaction denial message, such as a data format error message, back to the sender (e.g., the merchant 12) indicating that the payment transaction should be denied/declined. Although the following description is provided with reference to image biometric data, it should be appreciated that the present disclosure is not so limited and that other forms of available biometric data may be utilized herein in the same fashion (e.g., fingerprint data, retina data, voice data, heart rate data, etc.).

As depicted in FIG. 2, the user 22 (e.g., the consumer) can interact with the PTV module 28 through the use of a client system 32, which can be in the form of a mobile payment device (e.g., a smartphone, mobile phone, a table, a laptop, PDA, etc.). The user 22 can provide the necessary comparative biometric data with this mobile payment device and the PTV module 28 may obtain any relevant comparative metadata from this payment device.

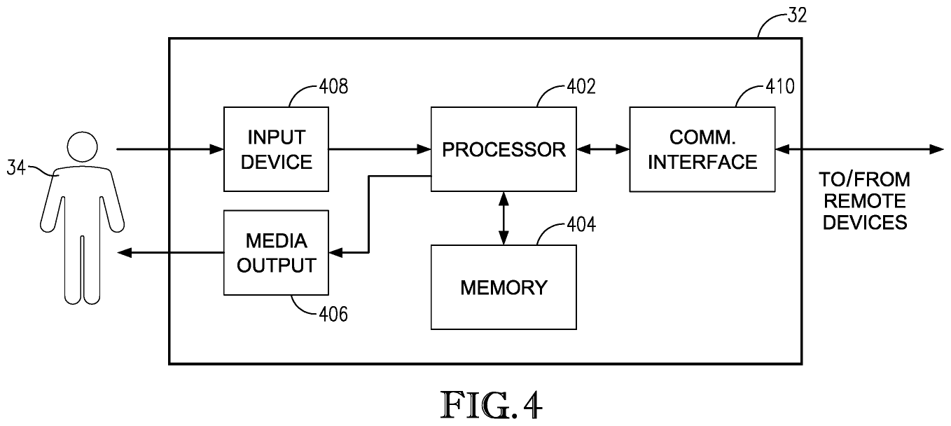

FIG. 4 illustrates an exemplary configuration of a client system 32. In the example embodiment, the client system 32 may include one or more processors 402 for executing instructions, processes, code segments, routines, or the like, which may be stored in a memory 404. The processor 402 may include one or more processing units, for example, a multi-core configuration. The memory 404 is any device allowing information such as executable instructions and/or other data to be stored and retrieved. The memory 404 may include one or more computer readable media.

The client system 32 may also include at least one media output component 406 for presenting information to users. The media output component 406 is any component capable of conveying information to an authorized user 34 (e.g., requests for biometric data, indications that biometric data matches or does not match, etc.). In some embodiments, the media output component 406 includes an output adapter such as a video adapter and/or an audio adapter. An output adapter is operatively coupled to the processor 402 and operatively couplable to an output device such as a display device, a liquid crystal display (LCD), organic light emitting diode (OLED) display, “electronic ink” display, an audio output device, a speaker, or headphones.

In some embodiments, the client system 32 includes an input device 408 for receiving input from the user 34. The input device 408 may include, for example, a keyboard, a pointing device, a mouse, a stylus, a touch sensitive panel, a touch pad, a touch screen, a gyroscope, an accelerometer, a camera, a position detector, an audio input device, or any other biometric reader device capable of retrieving biometric data from the user 34. In an exemplary embodiment, the input device 408 may comprise a camera for taking image data of the user 34. The input device 408 can be used to capture biometric data from the user 34, which can function as the current and comparative biometric data that is compared to the historical biometric data maintained by the PTV module 28.

A single component such as a touch screen may function as both an output device of the media output component 406 and the input device 408. The client system 32 may also include a communication interface 410, which is communicatively couplable to a remote device such as the server system 30. The communication interface 410 may include, for example, a wired or wireless network adapter or a wireless data transceiver for use with a mobile phone network, Global System for Mobile communications (GSM), 3G, 4G, Bluetooth or other mobile data network, or Worldwide Interoperability for Microwave Access (WIMAX).

Stored in the memory area 404 are, for example, computer readable instructions for providing a user interface to the user 34 via the media output component 406 and, optionally, receiving and processing input (e.g., current biometric data and metadata) from the input device 408. A user interface may include, among other possibilities, a web browser and a client application. Web browsers enable users, such as authorized user 34, to display and interact with media and other information typically embedded in remote applications, web pages, or websites.

Given the components of the payment network system 10 described above, embodiments of the present invention are configured to validate payment transactions by analyzing biometric data and metadata associated with such payment transactions. As previously noted, fraudulent actors have been known to generate fraudulent transaction messages and/or to modify valid transaction messages with fraudulent data. Such fraudulent or improperly-modified transaction messages can be used to authorize fraudulent payment transactions. To combat such scenarios, embodiments of the present invention, and particularly the PTV module 28, is specially configured to analyze biometric data and metadata associated with a payment account so as to determine the validity of associated payment transactions.

More particularly, the PTV module 28 can be configured to analyze and compare the comparative biometric data with the historical biometric data saved on the PTV module 28. The PTV module 28 can analyze the comparative biometric data to see if it matches the historical biometric data saved on the PTV module 28. The PTV module 28 may determine if there is a match between the retrieved comparative biometric data with the historical biometric data using a suitable algorithm (e.g., standard deviation, principal components analysis (PCA), linear discriminant analysis (LDA), elastic bunch graph matching (EBGM), etc.).

Additionally, the PTV module 28 can also be configured to analyze the comparative metadata from the client system 32 (e.g., the mobile payment device) of the user/consumer 22. The metadata that can be obtained and analyzed by the PTV module 28 can include, for example, timestamp metadata, geolocation metadata, camera model metadata, camera sensor metadata, mobile device model metadata, and/or camera sensor metadata from the client system 32 (e.g., a mobile payment device) of the consumer 22. In certain embodiments, the comparative metadata may be generated when a photo is taken by the client system 32 (e.g., the mobile payment device) of the user/consumer 22. In such embodiments, the metadata may or may not be embedded within the photo file (e.g., an EXIF file). The PTV module 28 can analyze and compare the comparative metadata to see if it corresponds to the historical metadata saved on the PTV module 28. The type of analysis the PTV module 28 utilizes to analyze and compare the metadata can depend on the type of metadata that is retrieved and analyzed.

In embodiments where the selected metadata comprises timestamp metadata from the payment device, the PTV module 28 can compare the comparative (i.e., comparative) timestamp metadata from the payment device to the historical timestamp metadata saved on the PTV module 28. In such embodiments, PTV module 28 can calculate a mean (i.e., average) time based on the historical timestamp metadata from the payment device. Consequently, the comparative timestamp metadata may correspond (i.e., be within an acceptable threshold) to the historical timestamp metadata when the comparative timestamp data is within 2, 3, 4, 5, 6, 7, or 8 hours of the calculated mean for the historical timestamp data.

In embodiments where the selected metadata comprises geolocation metadata from the payment device, the PTV module 28 can compare the comparative geolocation metadata from the payment device to the historical geolocation metadata saved on the PTV module 28. In such embodiments, PTV module 28 can formulate a map based on the average latitudes and longitudes of the historical geolocation metadata from the payment device. These maps can be formulated using simple algorithms (e.g., standard deviation, principal components analysis (PCA), linear discriminant analysis (LDA), elastic bunch graph matching (EBGM), etc.). Consequently, the comparative geolocation metadata may correspond (i.e., be within an acceptable threshold) to the historical geolocation metadata when the comparative geolocation data is within an acceptable latitude and longitude relative to the historical geolocation metadata. For instance, the comparative geolocation metadata may correspond to the historical geolocation metadata when it is within 10, 50, 100, 200, 300, 400, 500, 600, or 700 miles of the calculated latitudes and longitudes of the historical geolocation metadata.

In embodiments where the selected metadata comprises camera model metadata from the payment device, the PTV module 28 can compare the comparative camera model metadata from the payment device to the historical camera model metadata saved on the PTV module 28. In such embodiments, the comparative camera model metadata may correspond (i.e., be within an acceptable threshold) to the historical camera model metadata when the comparative camera model data matches the historical camera model metadata. For instance, the comparative camera model metadata may match the historical camera model metadata when both refer to the same camera model.

In embodiments where the selected metadata comprises mobile device model metadata from the payment device, the PTV module 28 can compare the mobile device model metadata from the payment device to the historical mobile device model metadata saved on the PTV module 28. In such embodiments, the comparative mobile device model metadata may correspond (i.e., be within an acceptable threshold) to the historical mobile device model metadata when the comparative mobile device model data matches the historical mobile device model metadata. For instance, the comparative mobile device model metadata may match the historical mobile device model metadata when both refer to the same mobile device model.

In embodiments where the selected metadata comprises camera sensor metadata from the payment device, the PTV module 28 can compare the comparative camera sensor metadata from the payment device to the historical camera sensor metadata saved on the PTV module 28. In such embodiments, the comparative camera sensor metadata may correspond (i.e., be within an acceptable threshold) to the historical camera sensor metadata when the comparative camera sensor metadata matches the historical camera sensor metadata. For instance, the comparative camera sensor metadata may match the historical camera sensor metadata when both refer to the same camera sensor model.

If the PTV module 28 determines that the comparative biometric data does not match the historical biometric data and/or that the collected comparative metadata does not correspond to the historical metadata, the interchange network 16 may send a payment transaction denial message to the sender (e.g., the merchant 12) indicating that the payment transaction is denied.

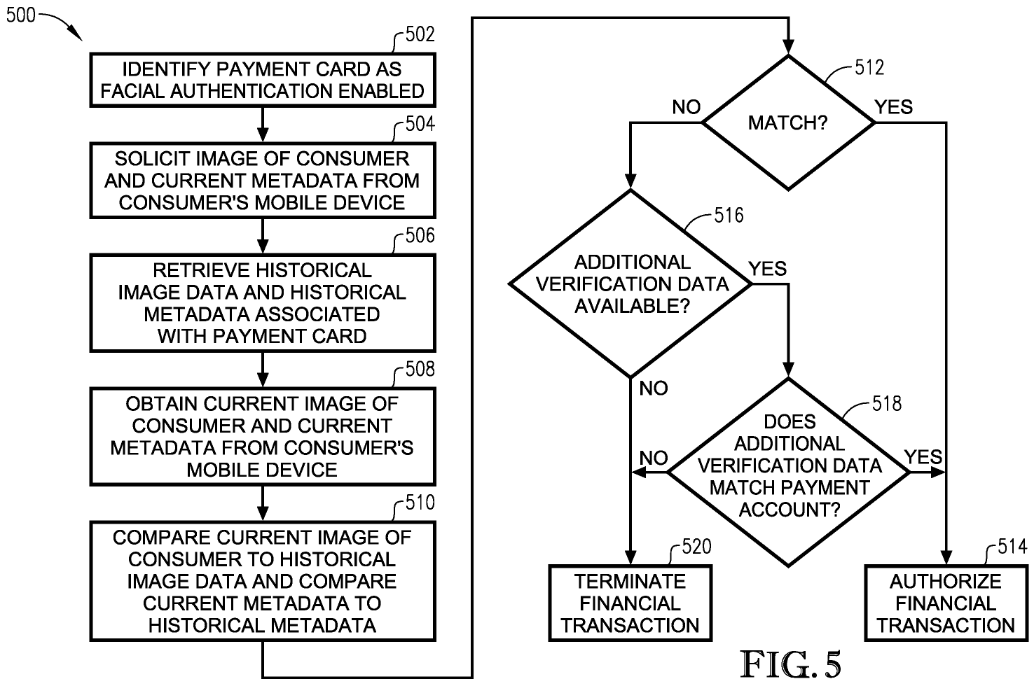

FIG. 5 broadly illustrates an exemplary method 500 for use in authenticating a consumer to a payment account based on biometric data and metadata from the consumer's payment device. While the following description of the method 500 is provided with reference to facial image biometric data, it should be appreciated that the present invention is not so limited and that other forms of biometric data may be utilized herein in a similar manner (e.g., fingerprint data, retina data, voice data, heart rate data, etc.).

When the consumer initiates a new financial transaction using a payment device (e.g., mobile phone, smartphone, tablet, computer, etc.), the PTV module 28 will identify 502 whether the payment account associated with the financial transaction is facial authentication enabled. In other words, the PTV module 28 will determine whether the payment account and the payment device allow the consumer to be authenticated by their biometric data (e.g., a facial image in FIG. 5). Next, the PTV module 28 will solicit 504 a comparative image from the consumer and the current metadata from the payment device. Additionally, the PTV module 28 will also retrieve 506 historical facial image data and historical metadata associated with the cardholder's previous payment devices. Steps 504 and 506 may occur simultaneously or at different times.

The PTV module 28 can then obtain 508 the current facial image from the consumer, who may send the image data using their payment device or a point-of-sale device, and the current comparative metadata associated with the payment device and image data. Upon receiving the facial image data and the current metadata, the PTV module 28 will then compare 510 the current image of the consumer to the historical image data saved on the PTV module 28 and compare the current metadata to the historical metadata saved on the PTV module 28. Next, the PTV module 28 determines 512 if the current image of the consumer and the current metadata match the historical image data and historical metadata, respectively.

If the PTV module 28 determines that the current image of the consumer matches the historical image data and that the current metadata corresponds to the historical metadata at an acceptable level, then the PTV module 28 can authorize 514 the financial transaction.

Alternatively, if the PTV module 28 determines that the current image of the consumer does not match the historical image data and/or that the current metadata does not correspond to the historical metadata at an acceptable level, then the PTV module 28 may request 516 additional verification data from the consumer. Further verification requirements can include, for example, providing a primary account number (PAN), a card verification value (CVV) code, the consumer's name, PIN authentication, signature authentication, and/or an expiration date for the payment account.

If additional verification data is provided by the consumer, then the PTV module 28 will analyze 518 this data to determine if it matches the payment account. If the additional verification data is deemed to match the payment account, then the financial transaction may be authorized 514.

If no additional verification data is provided by the consumer or the provided verification data fails to match the payment account associated with the financial transaction, then the financial transaction will be terminated 520.

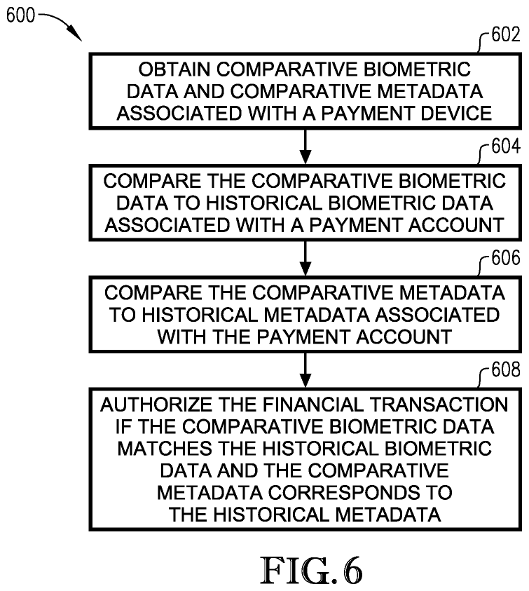

FIG. 6 depicts a flow chart of an exemplary computer-implemented method 600 for verifying a financial transaction (e.g., a payment transaction) initiated by a consumer. In this exemplary embodiment, the method 600 may be implemented by the PTV module 28, which was described above.

As shown in FIG. 6, the method begins by obtaining 602 comparative biometric data and comparative metadata associated with a payment device used by the consumer to initiate the financial transaction. Next, the PTV module 28 will compare 604 this comparative biometric data to the historical biometric data associated with the payment account for the financial transaction. In addition, the PTV module 28 will also compare 606 the comparative metadata to the historical metadata associated with the payment account for the financial transaction. Finally, the PTV module 28 may authorize 608 the financial transaction if the comparative biometric data matches the historical biometric data and the comparative metadata corresponds to the historical metadata.

It is noted that the computer-implemented method 600 may include more, fewer, or alternative operations, including those discussed elsewhere herein. Furthermore, any steps, actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

Embodiments of the present invention provide for the validation of payment transactions by analyzing biometric data and metadata from a payment device of a consumer. More particularly, the interchange network 16, including the PTV module 28 described above, may analyze this biometric data and metadata to determine whether associated payment transactions are valid or fraudulent.

A computer-readable storage media or medium comprising a non-transitory medium may include an executable computer program stored thereon. The computer program preferably instructs one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

### Definitions

It should be understood that the following is not intended to be an exclusive list of defined terms. Other definitions may be provided in the foregoing description, such as, for example, when accompanying the use of a defined term in context.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are illustrative only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory” “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments, but is not necessarily included. Thus, particular implementations of the present invention can include a variety of combinations and/or integrations of the embodiments described herein.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A computer-implemented method for verifying a financial transaction conducted over a payment network, the method comprising the steps of:
(a) obtaining comparative biometric data and comparative metadata from a payment device;
(b) comparing the comparative biometric data with historical biometric data associated with a payment account;
(c) comparing the comparative metadata with historical metadata associated with the payment account; and
(d) authorizing the financial transaction if:
(i) the comparative biometric data matches the historical biometric data, and
(ii) the comparative metadata corresponds to the historical metadata.

2. The computer-implemented method of claim 1, wherein the comparative metadata comprises comparative timestamp metadata and the historical metadata comprises historical timestamp metadata associated with the payment device, wherein the comparative timestamp metadata corresponds to the historical timestamp metadata when the comparative timestamp data is within 6 hours of a calculated mean for the historical timestamp data.

3. The computer-implemented method of claim 1, wherein the comparative metadata comprises comparative geolocation metadata and the historical metadata comprises historical geolocation metadata associated with the payment device, wherein the comparative geolocation metadata corresponds to the historical geolocation metadata when the comparative geolocation is within an acceptable latitude and longitude relative to the historical geolocation metadata.

4. The computer-implemented method of claim 1, wherein the comparative metadata comprises comparative camera model metadata and the historical metadata comprises historical camera model metadata associated with the payment device, wherein the comparative camera model metadata corresponds to the historical camera model metadata when the comparative camera model metadata matches the historical camera model metadata.

5. The computer-implemented method of claim 1, wherein the comparative metadata comprises comparative mobile device model metadata and the historical metadata comprises historical mobile device model metadata associated with the payment device, wherein the comparative mobile device model metadata corresponds to the historical mobile device model metadata when the comparative mobile device model metadata matches the historical mobile device model metadata.

6. The computer-implemented method of claim 1, wherein the comparative metadata comprises comparative camera sensor metadata and the historical metadata comprises historical camera sensor metadata associated with the payment device, wherein the comparative camera sensor metadata corresponds to the historical camera sensor metadata when the comparative camera sensor metadata matches the historical camera sensor metadata.

7. The computer-implemented method of claim 1, wherein the payment device comprises a mobile device.

8. The computer-implemented method of claim 1, wherein the comparative biometric data and historical biometric data comprise image data, fingerprint data, voice data, retina data, heart rate data, or combinations thereof.

9. The computer-implemented method of claim 1, wherein the comparative biometric data and historical biometric data comprise image data.

10. A financial transaction verification system for a payment network, the financial transaction verification system comprising:
(a) a memory device for storing data; and
(b) a processor communicatively coupled to the memory device, the processor programmed to:
(i) obtain comparative biometric data and comparative metadata from a payment device,
(ii) compare the comparative biometric data to historical biometric data associated with a payment account,
(iii) compare the comparative metadata to historical metadata associated with the payment account, and
(iv) authorize the financial transaction if the comparative biometric data matches the historical biometric data and the comparative metadata corresponds to the historical metadata.

11. The financial transaction verification system of claim 10, wherein the comparative metadata comprises comparative timestamp metadata and the historical metadata comprises historical timestamp metadata associated with the payment device, wherein the comparative timestamp metadata corresponds to the historical timestamp metadata when the comparative timestamp data is within 6 hours of a calculated mean for the historical timestamp data.

12. The financial transaction verification system of claim 10, wherein the comparative metadata comprises comparative geolocation metadata and the historical metadata comprises historical geolocation metadata associated with the payment device, wherein the comparative geolocation metadata corresponds to the historical geolocation metadata when the comparative geolocation is within an acceptable latitude and longitude relative to the historical geolocation metadata.

13. The financial transaction verification system of claim 10, wherein the comparative metadata comprises comparative camera model metadata and the historical metadata comprises historical camera model metadata associated with the payment device, wherein the comparative camera model metadata corresponds to the historical camera model metadata when the comparative camera model metadata matches the historical camera model metadata.

14. The financial transaction verification system of claim 10, wherein the comparative metadata comprises comparative mobile device model metadata and the historical metadata comprises historical mobile device model metadata associated with the payment device, wherein the comparative mobile device model metadata corresponds to the historical mobile device model metadata when the comparative mobile device model metadata matches the historical mobile device model metadata.

15. The financial transaction verification system of claim 10, wherein the comparative metadata comprises comparative camera sensor metadata and the historical metadata comprises historical camera sensor metadata associated with the payment device, wherein the comparative camera sensor metadata corresponds to the historical camera sensor metadata when the comparative camera sensor metadata matches the historical camera sensor metadata.

16. The financial transaction verification system of claim 10, wherein the payment device comprises a mobile device.

17. A non-transitory computer-readable storage media having computer-executable instructions for verifying a financial transaction conducted over a payment network stored thereon, wherein when executed by at least one processor the computer-executable instructions cause the processor to:
(a) obtain comparative biometric data and comparative metadata from a payment device;
(b) compare the comparative biometric data to historical biometric data associated with a payment account;
(c) compare the comparative metadata to historical metadata associated with the payment account; and
(d) authorize the financial transaction if the comparative biometric data matches the historical biometric data and the comparative metadata corresponds to the historical metadata.

18. The non-transitory computer-readable storage media of claim 17, wherein the comparative metadata comprises comparative timestamp metadata and comparative geolocation metadata,
wherein the historical metadata comprises historical timestamp metadata and historical geolocation metadata associated with the payment device,
wherein the comparative timestamp metadata corresponds to the historical timestamp metadata when the comparative timestamp data is within 6 hours of a calculated mean for the historical timestamp data, and
wherein the comparative geolocation metadata corresponds to the historical geolocation metadata when the comparative geolocation is within an acceptable latitude and longitude relative to the historical geolocation metadata.

19. The non-transitory computer-readable storage media of claim 17, wherein the comparative metadata comprises comparative camera model metadata, comparative mobile device model metadata, and comparative camera sensor metadata,
wherein the historical metadata comprises historical camera model metadata, historical mobile device model metadata, and historical camera sensor metadata associated with the payment device,
wherein the comparative camera model metadata corresponds to the historical camera model metadata when the comparative camera model metadata matches the historical camera model metadata,
wherein the comparative mobile device model metadata corresponds to the historical mobile device model metadata when the comparative mobile device model metadata matches the historical mobile device model metadata, and
wherein the comparative camera sensor metadata corresponds to the historical camera sensor metadata when the comparative camera sensor metadata matches the historical camera sensor metadata

20. The non-transitory computer-readable storage media of claim 17, wherein the payment device comprises a mobile device.
